(19) United States
(12) Patent Application Publication
(10) Pub. No.: US 2002/0109625 A1
(43) Pub. Date: Aug. 15, 2002

(54) Automatic method of tracking and organizing vehicle movement on the ground and of identifying foreign bodies on runways in an airport zone

(76) Inventor: Philippe Gouvary, Lamorlaye (FR)

Correspondence Address: JACOBSON, PRICE, HOLMAN & STERN, 400 Seventh Street, N.W., Washington, DC, 20004, US

(21) Appl. No.: 09/794,008

(22) Filed: Feb. 28, 2001

(30) Foreign Application Priority Data
Feb. 9, 2001 (FR) 0101785

(51) Int. Cl. G01S 13/93

(52) U.S. Cl. 342/29; 342/36; 342/55

(57) ABSTRACT

The automatic method of tracking and organizing the movements of vehicles on the ground in a zone of an airport comprises the steps consisting in:

acquiring data relating to the possible presence of at least one body in the zone;

analyzing the acquired data; and

where necessary as a result of the analysis, defining an action as a function of the result.

The method also makes it possible to detect the presence of a foreign body in zones over which airplanes can travel, and in particular on runways.

The invention relates to an automatic method of tracking and organizing vehicle movements on the ground in an airport zone, and includes a module for detecting foreign bodies on surfaces where traffic can pass, and it also relates to a system for implementing the method.

### BACKGROUND OF THE INVENTION

Unfortunately, it frequently happens that vehicle traffic on the ground in an airport is a source of delay, incidents, or even accidents. This applies equally well to travel on runways for takeoff and landing and to travel on taxiways enabling airplanes to go to a terminal from a landing runway or, conversely, to go to a takeoff runway from a terminal.

These traffic problems relate both to airplanes and to vehicles that travel on the ground only and that need to move along runways and taxiways for maintenance or safety reasons.

Conflicts, delays, or accidents can often arise either because of interaction between vehicles (where an airplane should be considered as being a kind of vehicle) or because of interaction between a vehicle and an obstacle or an animal, such as a bird.

More precisely, delays often arise because the traffic of airplanes heading for takeoff is poorly organized and can generate long queues. Another source of incidents or accidents is the presence on a runway of a foreign body that can harm the safety of vehicles and in particular of airplanes that are to use the runway. Another common case relates to the danger represented by birds present on runways or taxiways and capable of damaging airplanes and more particularly jet engines. Each of those problems stems, at least in part, from insufficient tracking and organization of vehicle movements on the ground.

### OBJECTS AND SUMMARY OF THE INVENTION

An object of the invention is to provide a method enabling the tracking and organization of vehicle movements to be improved in this context.

To this end, the invention provides an automatic method of tracking and organizing the movements of vehicles on the ground in an airport zone, the method comprising the steps consisting in:

acquiring data relating to the possible presence of at least one body in the zone;

analyzing the acquired data; and

where necessary as a result of the analysis, defining an action as a function of the result.

This method makes it possible to track more thoroughly how runways and taxiways are occupied and how vehicles are traveling thereon so as to avoid delays, incidents, and accidents.

The method of the invention can also present at least one of the following characteristics:

the zone comprises at least one takeoff and/or landing runway and/or at least one taxiway;

the acquisition step relates to the possible presence of at least one vehicle, in particular an airplane or a ground-only vehicle;

the body is a body other than a vehicle;

the data to be acquired relates to the actual presence of the body at the time of acquisition, or to the presence of the body at a time subsequent to acquisition;

the acquisition step comprises stages consisting in:

observing the zone by means of a camera; and

analyzing the recorded images;

the acquisition step comprises acquiring data relating to the dynamic behavior of the body, to identifying the body, or to locating the body;

when the body is a vehicle, the acquisition step includes a triangulation operation on the basis of a radio signal transmitted by the vehicle;

the method includes a step of acquiring data relating to:

present or forecast unavailability of the zone or of some other zone of the airport;

landings or takeoffs forecast in the airport;

future occupancy of at least one terminal of the airport; and

identifying vehicles, flights, codes, or correspondences therebetween;

the method includes the step of proposing the action to an operator or of executing the action;

the action comprises transmitting or ceasing to transmit a message;

transmission takes place by radio or by means of a display, in particular on a panel on the ground or on a screen;

the message is transmitted to a vehicle and/or a body situated in the zone or to an operator monitoring the zone;

when the analysis shows that conflict between a plurality of vehicles in the zone is possible, the action is arranged to contribute to organizing vehicle traffic so as to avoid the conflict; and

the method includes the step of displaying on a screen the present or future location(s) of the body(ies) in the zone.

The invention also provides an automatic system for tracking and organizing the movements of vehicles on the ground in a zone of an airport, the system comprising:

means for acquiring data relative to the possible presence in the zone of at least one body;

means for analyzing the acquired data; and

means for defining an action as a function of an analysis result.

The system of the invention can also present at least one of the following characteristics:

the acquisition means comprise at least one camera arranged to observe the zone, a radar, or a radio signal receiver;

the acquisition means are in communication with at least one airport database;

the databases can relate to at least:

airport landings and takeoffs;

the occupancy of at least one airport terminal;

the availability or non-availability of the zone or of some other zone of the airport; and

the identities of vehicles, flights, codes, and/or correspondences therebetween;

the database(s) can relate to the present or the forecast state of the airport;

the analysis means are suitable for locating a vehicle constituting the body by triangulation using a radio signal transmitted by the vehicle; and

the system includes means for executing the action, such as means for transmitting a message, e.g. a screen that can be consulted by an operator situated in control premises on the ground and/or a display panel situated in the zone or in the vicinity of the zone, for example suitable for displaying various messages.

The invention also provides a computer-readable data medium including a program suitable for implementing the method of the invention.

The invention also provides apparatus for detecting the presence of a body in a zone of an airport, the apparatus comprising at least one camera, video data acquisition means, and means for analyzing at least one camera image.

Finally, the invention also provides an automatic method of detecting the presence of a body in a zone of an airport, the method comprising the steps which consist in taking at least one video image of the zone and analyzing the image(s) taken.

The apparatus and the method make it possible to monitor the zone closely and continuously so as to detect an unusual presence in the zone as soon as possible, e.g. the presence of an object, a bird, or a vehicle parking for an abnormally long time. Parking time is a value that can be parameterized.

### BRIEF DESCRIPTION OF THE DRAWINGS

Other characteristics and advantages of the invention will appear on reading the following description of an embodiment and variants given as non-limiting examples. In the accompanying drawings:

FIG. 1 is a diagrammatic view of a zone of an airport showing various bodies that might be present in the zone and also showing certain portions of the system in the preferred embodiment of the invention for monitoring said zone;

FIG. 2 is a theoretical diagram showing one possible architecture for the system implementing the method of the invention;

FIG. 3 shows a data medium in accordance with the invention; and

FIG. 4 is a plan view showing one example of how cameras can be placed along a takeoff or landing runway in order to implement the invention.

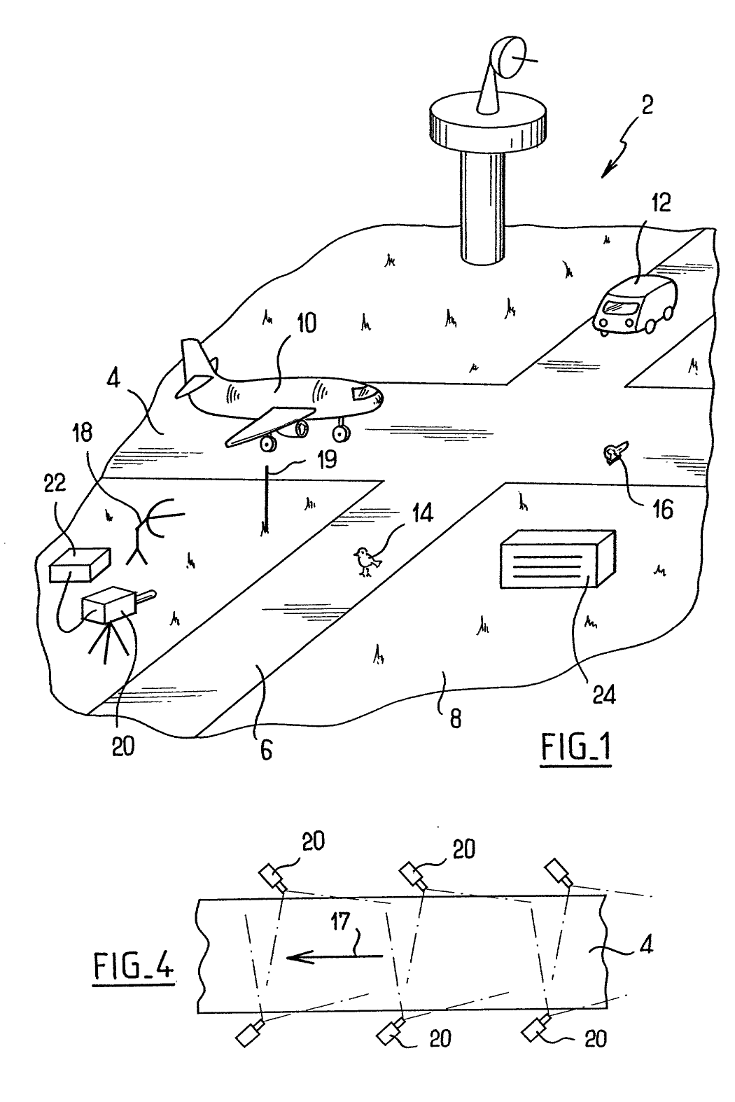

### MORE DETAILED DESCRIPTION

An embodiment of the invention is described below. The description begins by setting out the main functions of the method. The system and the means enabling these functions to be implemented are considered where appropriate while describing the method, and also in a second portion of the description.

The purpose of the automatic method is to track and organize vehicle movements on the ground in a zone 2 of an airport. The zone in question can have at least one takeoff and/or landing runway 4, at least one taxiway, and/or adjacent land that is not itself intended to be traveled over by vehicles, for example a patch of grass 8. When the zone 2 is constituted by one of these elements only, the method is implemented on a relatively small scale. Preferably, the method is implemented in a zone 2 that comprises all of the takeoff and landing runways and all of the taxiways of an airport. However the airport could be notionally subdivided into a plurality of zones with the method being implemented in each of them.

The method implements monitoring and analysis of all bodies that might be found in the monitored zone 2. Thus, the method takes account of all airplanes 10 traveling on the ground in the zone or parked therein. The method also takes account of all vehicles 12 other than airplanes traveling or parked in the zone. By way of example, these can be maintenance vehicles for airplanes or runways, cleaning vehicles, passenger and/or baggage transport vehicles, emergency vehicles, etc.

Finally, the method also takes account of all bodies whose presence in the zone is unusual. By way of example these can comprise animals 14 such as birds which can constitute a danger for the jet engines of airplanes. These can also be any objects or debris 16 that might be found on the ground and that might interfere with the movements of vehicles, be they airplanes 10 or ground-only vehicles 12.

The method comprises essentially three steps constituted respectively by acquiring data, processing the data, and where appropriate, depending on the result of the processing, defining an action.

### Data Acquisition

The data to be acquired can relate to the presence of a body 10, 12, 14, 16 in the zone at the time the data is acquired. However, and advantageously, the data can also relate to the presence of the bodies in the zone at some moment subsequent to acquisition such that the data relates to a forecast presence in order to be able to anticipate said presence. The acquisition step preferably implements various stages which consist in detecting the presence, if any of a body, in identifying the body in question, in locating said body, in determining its dynamic status (moving or stationary), and finally in determining its speed and path, where appropriate.

Data acquisition can be implemented by various means. Thus, to implement the method, it is possible to use a radar 18. However, the use of radar should be reserved to circumstances where the geography of the airport makes that possible, since otherwise certain portions of the zone might be left without cover.

The system can also have at least one video camera 20 placed in the zone 2 or in the vicinity of the zone to observe the zone. The camera(s) is/are associated with means 22 for processing the video images picked up by the camera(s). The processed images are then analyzed to determine the presence of a body in the field of view of the camera, if any such body is present, and where appropriate to determine its characteristics. This analysis can rely on comparing the most recently picked-up image with a typical image so as to detect the presence of a foreign body in the field of the camera. The cameras can be digital cameras in which image analysis is performed with reference to a background image. The reference can be variable. Thus, information picked up on a continuous basis is applied to a video matrix and to a data acquisition front end. Warnings are generated depending on how parameters are set (length of time stationary on a runway, handling false alarms, etc.).

The data acquisition step also comprises a stage which consists in collecting data from various databases already available in the airport but often separate from one another since they belong to different services or organizations.

Thus, in order to be able to track and organize vehicle traffic in the zone appropriately, it is useful at the time of acquisition to have data specifying which zone and more particularly which runway or which taxiway of the airport is available or unavailable for reasons of cleaning or maintenance, and above all which zones are planned to become unavailable at some determined later time. Subsequently, while defining an action as a function of the data, account can be taken of such information to organize vehicle traffic in the zone 2 in the most suitable manner given any non-availabilities.

Other data to be acquired from certain databases includes all of the data relating to forthcoming landings and takeoffs in the airport. Similarly, data is collected related to expected occupancy of various terminals of the airport or indeed of all of the terminals. These two groups of data serve to organize vehicle traffic and in particular airplane traffic in the zone in question by anticipating their departure and arrival times as accurately as possible, and also the times during which they will be occupying an airport terminal, and above all the various paths that the vehicles need to follow between the runways and the terminals while using the taxiways, in association with the corresponding times. The method can take account of the departure time and the dispatch and pushback times as a function of the need to pass through a deicing facility in winter.

Finally, data acquisition can advantageously involve consulting databases relating to the identity of vehicles, flights, vehicle codes, and flight codes, and above all to the correspondence tables therebetween. Of particular use in this data are the transponder codes whereby vehicles and in particular airplanes identify themselves by radio with the radio recognition equipment of airports. Knowledge of this code makes it possible quickly to identify a vehicle that is to be found in the zone because of the radio identification means used in the context of this method.

Identification could possibly be done by means of badges or bar codes, depending on how regulations evolve.

When the body is a vehicle, the locating means could also comprise means for locating the vehicle by radio by triangulation or by radar or by radio location, for example like the SYLETRAC equipment used by ADP at Roissy-Charles de Gaulle Airport on the basis of a radio signal transmitted by the vehicle. The system for locating vehicles by triangulation could make use of receiver antennas 19 for receiving signals from vehicle transponders, regardless of whether the transponder is in mode C or in mode S. Alternatively or as well, the locating means could include a system for GPS positioning. Finally, the system could also implement identification by differential GPS. In addition, the system preferably makes it possible to locate each body with x, y, and z coordinates.

This data can be acquired by the above-mentioned means, or by proximity detector means or by various sensors.

The coverage density of the various means over the zone (e.g. magnetic sensors and/or cameras) will be particularly high at the intersections between runways 4 and taxiways 6, and also at the intersections between certain taxiways 6, or where runways cross. Preferably, in order to ensure that the radio signals used by the method do not saturate the radar screens of the controllers in the control tower, it is possible to fit masks to the screens of the controllers.

FIG. 4 shows one example of how cameras 20 in the system of the invention can be placed along a takeoff or landing runway 4. A plurality of cameras 20 are placed along each side of the runway and they are spaced apart from one another at a constant pitch p, e.g. lying in the range 40 meters (m) to 50 m, and which can be adapted in particular as a function of the technology used.

The cameras are directed towards the runway at an angle of less than 90° and they face slightly upstream relative to the usual travel direction 17 of airplanes on the runway. The fields of view of the cameras overlap both within each row and between rows.

The method enables the presence of airplanes and of ground-only vehicles in the zone in question to be detected and labeled, i.e. the vehicles to be identified. The method also makes it possible to detect the presence of a foreign body in said zone, such as an object or an animal. By collecting data relating to when such and such a part of the airport is going to be unavailable, both for the day in question and for the future, the method can take account of projected durations for maintenance, closure, and major repair work. As explained below, the maintenance service can itself be a user of the method and the system of the invention for the purpose of determining the occasions that are most suitable for performing such and such work that can make a zone unavailable, at least in part (handling interactions between operators).

In other words, the data acquisition step can include in particular an identification step and a step of tracking “products”, where the term “products” is used to cover the vehicles which the method is to monitor and whose traffic it is to organize. The various data collected from the above-mentioned databases preferably relates both to the present state of the airport and to forecasts concerning the future state of the airport.

Within the frame of reference of the “airport zone”, the method makes it possible to identify airplanes and other vehicles traveling on taxiways and runways by determining the presence thereof and the identity thereof. It also serves to identify foreign bodies on the runways.

The identity of each vehicle, airplane or other vehicle, whose presence is detected in the zone is preferably correlated with other data to verify that its presence is appropriate. For airplanes approaching to land in the zone, such airplanes can be identified advantageously before they land, e.g. by means of the approach radar of the airport.

As mentioned above, an important function of the method is to detect continuously and in all weathers, in particular during very poor visibility, any foreign body lying on a runway and of a kind that has the potential of endangering any vehicle traveling on the ground, in particular an airplane during takeoff or landing. In this respect, the data acquisition stage serves to detect on a continuous basis the presence of any such object, and to record a moving picture constituting a video log of landings and takeoffs. The method can be implemented at night by using infrared cameras. As described below, if the presence of an abnormal object is detected, then a warning can be triggered and the warning can be sent to one or more operators. The method serves to improve techniques for combating bird hazard (the danger that birds represent for airplanes).

It is preferable for presence detection to be infallible or to trigger a warning only when the method is no longer capable of guaranteeing some defined performance. The best approach is to arrange such a detection system so that it is redundant, e.g. by using both radar monitoring and identification by triangulation (as implemented by the AN/TPS-59 sold and developed by Sensis Corporation, 5793 Widewaters Parkway, Dewitt, N.Y., 13214, USA).

Naturally, the acquisition step also serves advantageously to pick up other data. Thus, in association with the detection systems that are usual in airports, the method can collect data relating to detection and metering loops. It is possible to use data from ground radar and from approach radar. It could make use of data coming from other systems for detecting items on runways. It can take account of the status of traffic lights and of lights giving access to runways, and also the state of display panels 24 present within the zone.

In order to centralize the acquisition of all the above data, the system that enables the method to be implemented comprises (cf. FIG. 2) data acquisition frontends 26 each dedicated to a respective type of data. By way of example, one frontend acquires all of the data relating to identifying airplanes and other vehicles, another frontend collects data relating to the state of signaling within the zone, another relates to data involving the detection of a foreign body in the zone, etc. The data acquisition frontends 26 are independent of one another and they enable the system to be managed under all circumstances, including those involving degraded operation (for example in the event of a server breakdown or in the event of anomalies in an operator substation).

Data acquisition also makes use of acquisition servers for handling the data that has been acquired by the frontends. With reference to FIG. 2, these servers comprise a “normal” acquisition server 28 and a “backup” acquisition server 30 in a redundant configuration therewith.

### Data Processing

After data has been acquired, implementation of the method consists in processing the data and in taking account of the results of said processing in order to define an action plan.

As can be seen in FIG. 2, the computer technique implemented herein lies in separating the data acquisition stage from the stage of processing said data. The processing of the data and the recommending of action are performed by a “normal” operating system 32 and by a redundantly configured “backup” operating system 34.

The system can be designed so as to propose the action defined in this way to an operator, and in certain predetermined circumstances, to perform the action directly.

The action can be constituted by sending a message or on the contrary by ceasing to send a message if that had been going on beforehand. The message can be a warning, e.g. transmitted by radio to a person on board a vehicle 10, 12, and/or sent by means of a display, in particular via a panel on the ground 24 and/or a screen 40 belonging to one of the operators. In particular, the panel can be a variable message panel of the kind used commonly for road safety purposes. The system can include an automatic voice message generator that generates messages in particular for vehicles 10 and 12. Regardless of the content of the message, it can be intended for a vehicle and/or for a body situated in the zone, or it can be intended for an operator monitoring the zone, in which case it is advantageous for the message to be sent to a monitor screen 40 of that operator. For an operator, the step of defining action can also include a stage which consists in using the operator's screen to display the present location or the future location of the or each body 10, 12 within the zone 2. Such display is preferably possible on a continuous basis and it is preferably constantly updated.

In the event where analysis shows that conflict is possible between a plurality of bodies in the zone, and in particular between a plurality of vehicles, the action is arranged to contribute to organizing vehicle traffic so as to avoid conflict. For example, the action can consist in sending one given message to at least one of the vehicles and in sending a different given message to the other vehicle.

The method can manage warnings in conventional manners and can trigger:

action on the ground by an operator: a patrol can be sent to the site, and a message can be sent to a vehicle used for monitoring purposes, and a picked-up video image can be sent to the vehicle (acknowledgment of false warnings and processing warnings);

radio contacts; and

controlling signaling to convey information to the pilot/driver of vehicles in the zone.

Naturally, it is preferable to provide suitable parameterization so as to be able to detect abnormally long stationary periods for a vehicle in the zone while simultaneously not issuing numerous false warnings. Other parameterizations can be implemented within the method.

The various operators of the method shown in FIG. 2 are the persons or organizations that receive the results of the data analysis. The method is organized in such a manner that, in predetermined circumstances, various actions are automatically executed, possibly in association with the operators in application of previously validated action plans, or else such actions are merely suggested to the operators.

As can be seen in FIG. 2, the number of operators in the system can be large. For example, the following are considered to be operators: the airport supervisor; the control tower service; the ground control service; and the maintenance service. The operators can also include the organization in charge of clearance delivery and emergency services.

By way of example, the server 32 can be connected to the following operator stations:

maintenance;

voice message generator;

ground control;

clearance delivery;

control tower;

remote image sending; and

emergency services.

After analyzing the data received from the acquisition server 28, the operating system 32 handles actions with the various operators by means of their personal computers 40. The operating system is programmed to know the operators and each of their prerogatives as a function of such and such a situation.

Each operator station has one or more screens 40 enabling the operator to view the current situation and the action proposed by the system, e.g. in outline. The operator also has input means enabling the operator to input new data into the system, e.g. the location and time of work that is imminent. Such data input means might comprise a light pen, for example. When the maintenance service inputs new data relating to the non-availability of a taxiway, this might give rise to a warning for the control operator who will then be required to validate or modify the proposal made by the maintenance service as a function of the activity of the airport. Given this information, the system then acts throughout the period of non-availability to generate routes from the terminals to the runways, and vice versa, that facilitate organizing the traffic involving the various vehicles. These routes are communicated to the operators, in particular those having control functions. They also enable signaling to be activated so as to make it easier for pilots to identify the route designated by control. Ground signaling will refuse airplanes access to zones that are not available, and radio messages generated by the voice server will be consistent with this situation.

Naturally, the system is modular and can be expanded as a function of the needs or constraints of the operators. Agreement might be reached to provide users such as the pilots or drivers of vehicles in the zone 2 with information coming directly from the system, in addition to the radio that they normally receive.

It is also possible to connect a development station 36 to the system for the purpose of trying out new applications before they are implemented in a real situation. Similarly, it is possible to train new operators (e.g. a controller) using a training station 36 that makes use of data that has been archived or of data that is arriving in real time.

The operating system is designed to act automatically to manage a log of events that have occurred. Advantageously, the system will include a “log” server 37 that makes it possible to work in deferred time on archived data for the purposes of improving the system, possibly by modifying one or more predetermined plans of action, or of testing a new action plan before it is used at full scale. The log server 37 also serves to recover data in the event of an incident or an accident. The processing of information in deferred time in the log server preferably takes place as an internal loop which alternates with steps devoted to archiving and to analysis.

When the system proposes an action to an operator, the operator is free under certain circumstances to validate or to refuse to validate the proposed action.

All of the actions of the various operators depend on the functional analysis that must be made of each airport and for each operator. The examples given below are merely general examples that can be applicable in some airports.

### Maintenance

In real time: interaction with ground control serves to request authorization to act on taxiways and on runways without waiting for any kind of “meeting”. The system then makes it possible to have an updated summary displayed on the screens of other operators (ground control and control tower in particular).

In deferred time: log analysis can improve interventions and can target them better, and possibly also begin analytic accounting if none is already in existence. This analysis also makes it possible to study how cooperation takes place between services (where such co-operation sometimes “jams”).

### Ground Control

In real time, the following is made available:

a proposed route which can be amended (light pen on a screen or by means of a computerized graphics tablet);

proposed dispatching depending on constraints associated with traffic and possible deicing (as a function of outside temperature and the effectiveness of the deicing substance);

means for taking action via the variable message panels, the traffic lights, and the call generating machine which controls routes and emergency actions (immediate stop, intrusion, etc. . . . ); and

traditional radio means.

Ground control is fully aware of which zones are accessible or not accessible as a function of works (display on a summary). It does not have the possibility of changing these accesses inadvertently or by any other maneuver.

In deferred time, ground control has available to it an archive of overall operation with dispatch times, routes, its own actions associated with the name of the person who issued the instructions (going on watch) etc. This archive makes it possible to perform analysis in order to improve the safety of the service.

### Control Tower

In real time: it is aware of the maximum queue length (since that is defined in the parameterization). It is aware of the delay or slippage relative to the original plan.

In deferred time: the control tower has an archive of the overall operation with times of alignment and takeoff and landing and leaving the runways, its own actions including the names of the people issuing the instructions concerned (going on watch), etc. This archive makes it possible to perform subsequent analysis in order to improve the safety of the service.

### Clearance Delivery

In real time: control is aware of the current queue and when takeoff might be possible. It is aware of the difference relative to the original plan. Taxiway unavailability is of little importance to it.

In deferred time: control has the archive of overall operation. This archive can be used for subsequent analysis in order to improve the safety of the service.

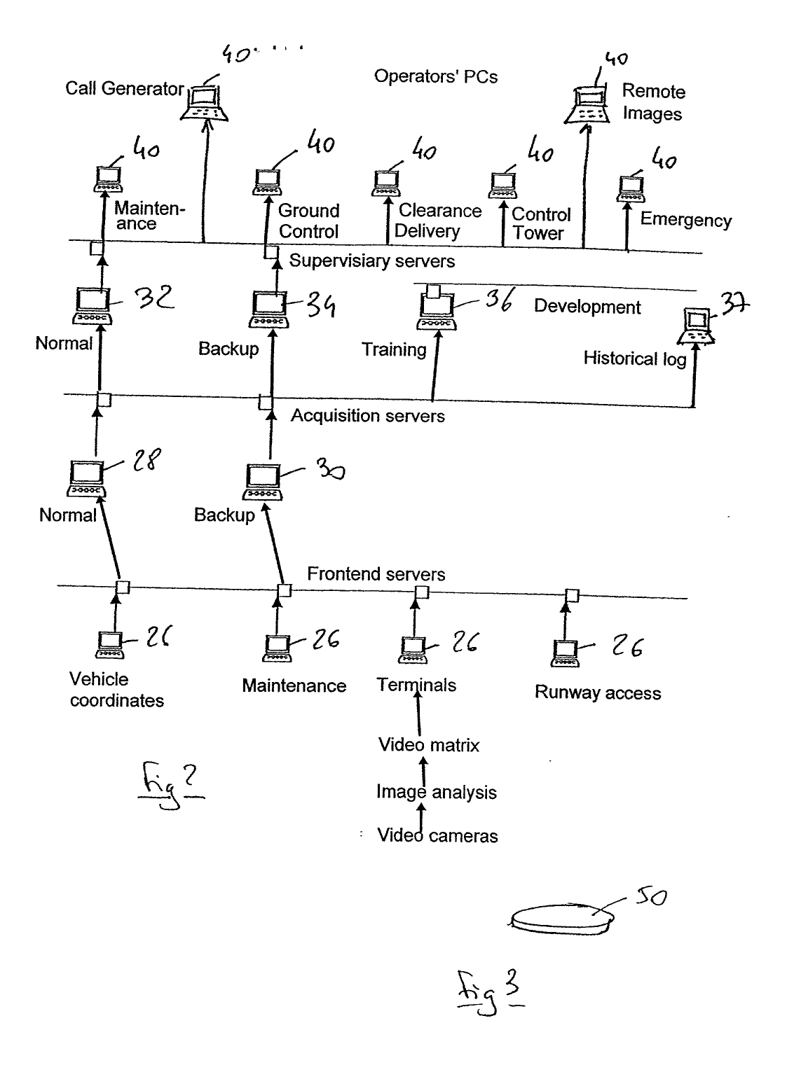

The program governing implementation of the method in the system can be constituted by software and, where appropriate, it can be stored on a data medium 50 that is suitable by being read by a computer, as shown in FIG. 3.

In the context of the method and the system of the invention, airplanes and vehicles are “products” in the same sense as products on a production line: they are managed within an airport zone in dynamic manner and in various stages: elements are identified and then tracked from an origin to a destination with possible conflicts being catered for. Queues are generated in optimized manner, and the system has specific modules for detecting anomalies, such as foreign bodies or parts being identified on the runways, or in sensitive locations as defined by any of the operators.

Naturally, the system is modular and can be enriched with various functions to keep up with developments in the technology of certain sensors or the desires of any of the operators.

The method and the system provides coordination between the various operators on an airport platform, as constituted in particular by runway cleaning and maintenance services, air traffic control services (clearance delivery, ground control, control tower), and operators in charge of bird hazard and of emergency services. The method of the invention provides real time coordination between these various services by giving the positions within the zone in question of airplanes, of other vehicles, and of foreign bodies, and also by managing predefined action plans. The system is informed by an array of specific sensors that make it possible to identify and track airplanes and other vehicles authorized to travel on taxiways and runways. The invention makes it possible to determine their precise positions within the airport zone relative to a geographical frame of reference for the airport as a whole. The invention makes it possible to detect foreign bodies on runways. The system is suitable for generating alarms and for detecting false alarms, in particular by means of its parameterization. It triggers alarms as a function of predefined action plans and of parameterized values. Finally, it provides coordination between the various operators and integrates their respective action plans. The method of the invention provides decision-making assistance to the various operators. It can act by radio or by visual display (panels and pictograms) and it performs processing in real time as well as in deferred time on the data it has acquired.

For runway and taxiway maintenance purposes, it is known that maintenance services need to take various sections of runway or taxiway out of operation for certain lengths of time. The method thus enables the various operators involved with the method to view those sections that are unavailable or that are going to become unavailable.

The system of the invention is suitable, in particular, for being implemented by adapting the system known as Détection Automatique d'Incidents (DAI) [Automatic incident detection] which analyzes video images and which is sold by Citilog Média4 of 5 avenue d'Italie, 75013 Paris, France, and which is designed for a road network.

The invention provides numerous advantages of various kinds.

In terms of safety, the system enables airlines to reduce their civil liability exposure, for example by being the owner of an airplane that has left a part lying on a runway. The system makes it possible to guarantee spacing between airplanes while taxiing, with this being by means of a value that can be parameterized. The system makes it possible to reduce the risk of an accident following a tire burst, or to reduce the seriousness of such an accident, and thus to reduce the cost of any repairs that might be needed. The system makes it possible to reduce or even eliminate the risk of incursion onto a runway. It serves to manage conflicts at intersections. By reducing pointless waiting time both on landing and on takeoff it increases the fuel reserves in airplanes on arrival.

For operators in airports, the system serves to monitor runways on a continuous basis. It reduces risks of criminal liability by improving the quality of runway inspection. It enables taxiway occupancy to be reduced and also the number of airplanes taxiing simultaneously on the runways and taxiways. It can provide images of takeoff and landing and it can archive them. It makes it possible to reconstitute a sequence of events.

An advantage of the invention is also economic. Thus, for airlines, the invention manages fuel economy and reduces the risks and financial consequences of a tire burst. The system also reduces the time spent by airplanes taxiing on the ground and consequently the time their engines are running. It enables operators to optimize the capacity of the airport.

Finally, the invention is also of use to the pilots or drivers of vehicles, in particular of airplanes. The invention organizes and facilitates the marking of the route to be followed by an airplane between a terminal and a runway, and vice versa. It improves ground safety. In the event of an incident on the ground, it improves the organization and traffic of airplanes. It makes it possible to reduce pilot waiting times on taxiways before takeoff.

The system is also advantageous for controllers. It constitutes an automatic system for providing assistance in avoiding collisions on the ground, for example as an incursion onto a runway where it crosses a taxiway or on a main section of runway, particularly under conditions of poor visibility. It makes it possible to reduce the number of radio messages needed for guiding airplanes between a terminal and a runway. It provides assistance in starting airplanes by taking account of various parameters (deicing, relative positioning of terminal and runway, number of airplanes taxiing, takeoff slots, etc.). It enables new controllers to be trained and it provides time savings to all of control staff making them more available for safety work.

1/ An automatic method of tracking and organizing the movements of vehicles on the ground in an airport zone, the method comprising the steps consisting in:
acquiring data relating to the possible presence of at least one body in the zone;
analyzing the acquired data; and
where necessary as a result of the analysis, defining an action as a function of the result.

2/ A method according to claim 1, wherein the zone comprises at least one takeoff and/or landing runway and/or at least one taxiway.

3/ A method according to claim 1, wherein the acquisition step relates to the possible presence of at least one vehicle, in particular an airplane or a ground-only vehicle.

4/ A method according to claim 1, wherein the body is a body other than a vehicle.

5/ A method according to claim 1, wherein at least some of the data to be acquired relates to the actual presence of the body at the time of acquisition.

6/ A method according to claim 1, wherein some of the data to be acquired relates to the presence of the body at a time subsequent to acquisition.

7/ A method according to claim 1, wherein the acquisition step comprises stages consisting in:
observing the zone by means of a camera; and
analyzing the recorded images.

8/ A method according to claim 1, wherein the acquisition step includes acquiring data concerning the dynamic behavior of the body.

9/ A method according to claim 1, wherein the acquisition step includes identifying the body.

10/ A method according to claim 1, wherein the acquisition step includes locating the body, and in the event of the body being a vehicle, it preferably includes an operation of triangulation on the basis of a radio signal transmitted by the vehicle.

11/ A method according to claim 1, including a step of acquiring data relating to:
present or forecast unavailability of the zone or of some other zone of the airport;
landings or takeoffs forecast in the airport;
future occupancy of at least one terminal of the airport; and
identifying vehicles, flights, codes, or correspondences therebetween.

12/ A method according to claim 1, including a step of proposing an action to an operator.

13/ A method according to claim 1, including a step of executing an action.

14/ A method according to claim 1, wherein the action comprises sending a message.

15/ A method according to claim 14, wherein the message is sent by radio.

16/ A method according to claim 14, wherein the message is sent by means of a display, in particular on a screen (40) and/or on a panel on the ground.

17/ A method according to claim 14, wherein the message is sent to a vehicle situated in the zone and/or to an operator monitoring the zone.

18/ A method according to claim 1, including a step of representing the present or future location(s) of the body(ies) in the zone on a screen.

19/ An automatic system for tracking and organizing the movements of vehicles on the ground in a zone of an airport, the system comprising:
means for acquiring data relative to the possible presence in the zone of at least one body;
means for analyzing the acquired data; and
means for defining an action as a function of an analysis result.

20/ A system according to claim 19, wherein the acquisition means comprise a camera arranged to observe the zone.

21/ A system according to claim 19, wherein the acquisition means comprise a radar.

22/ A system according to claim 19, wherein the acquisition means comprise a radio signal receiver.

23/ A system according to claim 19, wherein the acquisition means are in communication with one or more airport databases, in particular relating to the following at least:
takeoffs and landings in the airport;
the occupancy of at least one terminal of the airport;
the availability or unavailability of the zone or of some other zone of the airport; and
the identities of vehicles, flights, codes, and/or correspondences therebetween.

24/ A system according to claim 19, wherein the analysis means are suitable for locating a vehicle constituting the body by performing triangulation on the basis of a radio signal transmitted by the vehicle.

25/ A system according to claim 19, including means for sending a message, in particular a display panel situated in the zone or in the vicinity of the zone, and suitable for example for displaying a variety of messages, or a screen that can be consulted by an operator.

26/ A computer-readable data medium, carrying a program suitable for implementing the method according to claim 1.

27/ Apparatus for detecting the presence of a body in a zone of an airport, the apparatus comprising:
at least one camera;
means for acquiring video data coming from the camera(s); and
means for analyzing the data.

28/ An automatic method of detecting the presence of a body in a zone of an airport, the method comprising the steps consisting in:
picking up one or more video images of the zone; and
analyzing the picked-up image(s).
